(19) United States
(12) Patent Application Publication
(10) Pub. No.: US 2017/0154034 A1
(43) Pub. Date: Jun. 1, 2017

(54) METHOD AND DEVICE FOR SCREENING EFFECTIVE ENTRIES OF PRONOUNCING DICTIONARY

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Junbo ZHANG, Beijing (CN)

(21) Appl. No.: 15/241,682

(22) Filed: Aug. 19, 2016

Related U.S. Application Data
(63) Continuation of application No. PCT/CN2016/082538, filed on May 18, 2016.

(30) Foreign Application Priority Data
Nov. 26, 2015 (CN) 201510848815.X

(51) Int. Cl. G06F 17/27; G06F 17/24

(52) U.S. Cl. CPC G06F 17/2735; G06F 17/24

(57) ABSTRACT

Some embodiments of the present disclosure provide a method and a device for screening effective entries of pronouncing dictionary. Wherein, the method includes: traversing each entry of a speech dictionary, invoking a pre-trained statistical model, and scoring the entry according to a preset scoring strategy, wherein a comparison relation between the entry and corresponding pronunciation distributions is saved in the statistical model; and screening the scored speech dictionary according to a preset screening strategy to obtain an optimized pronouncing dictionary. Some embodiments of the present disclosure implement low-cost and highly efficient pronouncing dictionary optimization, and improve the recognition rate of the pronouncing dictionary at the same time.

### CROSS-REFERENCE TO RELATED APPLICATION

This application is a continuation of International Application No. PCT/CN2016/082538, filed on May 18, 2016, which is based upon and claims priority to Chinese Patent Application No. 201510848815.X, filed on Nov. 26, 2015, the entire contents of which are incorporated herein by reference.

### TECHNICAL FIELD

Some embodiments of the present disclosure generally relate to the field of speech technologies, and more particularly, to a method and a device for screening effective entries of pronouncing dictionary.

### BACKGROUND

A pronouncing dictionary is an important part of a speech recognition system that describes the pronouncing method of words. For Mandarin Chinese, a common problem is that the pronouncing dictionary often has a lot of redundant entries. The reason for this problem is that the pronouncing dictionary is usually generated by a computer through a manner of consulting dictionaries automatically, while Chinese has a lot of polyphones, and it is difficult for the computer to determine which pronunciation of the polyphones shall be used to generate the pronouncing dictionary, and the computer has to use all the pronunciations to generate entries of the pronouncing dictionary. This results in that the pronunciations of a large number of entries in the dictionary are unused in practice.

As to the redundancy problem of dictionary, if the redundancy is indulged and not dealt with, the dictionary with redundancy is applied to the speech recognition system, which brings the wasting of space and time and the reduction of recognition accuracy rate to some degree.

In the prior art, artificial screening is a processing method specific to the entry redundancy of dictionary to delete unwanted pronunciations. This method can effectively solve the redundancy problem of dictionary entry, but the defects are its high cost and excessive workload.

Therefore, it is highly desirable to propose a highly efficient method for screening effective entries of pronouncing dictionary.

### SUMMARY

Some embodiments of the present disclosure provide a method and a device for screening effective entries of pronouncing dictionary for solving the defects of high cost and excessive workload for artificially screening pronouncing dictionary to solve the resource redundancy of the pronouncing dictionary in the prior art, and implements automatic screening of the effective entries of the pronouncing dictionary.

Some embodiments of the present disclosure provide a method for screening effective entries of pronouncing dictionary, including:

traversing each entry of a speech dictionary, invoking a pre-trained statistical model, and scoring the entry according to a preset scoring strategy, wherein a comparison relation between the entry and corresponding pronunciation distributions is saved in the statistical model; and

screening the scored speech dictionary according to a preset screening strategy, and obtaining an optimized speech dictionary.

Some embodiments of the present disclosure provide an electronic device for screening effective entries of pronouncing dictionary, including:

at least one processor; and

a memory communicably connected with the at least one processor for storing instructions executable by the at least one processor, wherein execution of the instructions by the at least one processor causes the at least one processor to:

traverse each entry of a pronouncing dictionary, invoke a pre-trained statistical model, and score the entry according to a preset scoring strategy, wherein a comparison relation between the entry and corresponding pronunciation distributions is saved in the statistical model; and

screen the scored pronouncing dictionary according to a preset screening strategy and obtain an optimized pronouncing dictionary.

The method and device for screening effective entries of pronouncing dictionary provided by some embodiments of the present disclosure use a certain number of corpus databases to train the statistical model, so as to judge whether the entry of the speech dictionary is an effective entry according to the statistical model, thus changing the defect of entry redundancy of the present pronouncing dictionary and optimizing the present pronouncing dictionary; meanwhile, compared with the defect of the prior art that requires a lot of artificial work to screen invalid entries, some embodiments of the present disclosure implement highly efficient and low-cost deletion of the invalid entries automatically.

### BRIEF DESCRIPTION OF THE DRAWINGS

In order to explain the technical solutions in some embodiments of the disclosure or in the prior art more clearly, the drawings used in the descriptions of some embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a technical flow chart of some embodiments of the present disclosure;

FIG. 2 is a technical flow chart of some embodiments of the present disclosure;

FIG. 3 is a technical flow chart of some embodiments of the present disclosure;

FIG. 4 is a structural diagram of a device of some embodiments of the present disclosure;

FIG. 5 is a technical flow chart of the present disclosure; and

FIG. 6 is a block diagram of an electronic device in accordance with some embodiments.

### DETAILED DESCRIPTION

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

It should be illustrated that some embodiments of the present disclosure do not exist independently, but may be mutually combined or supported.

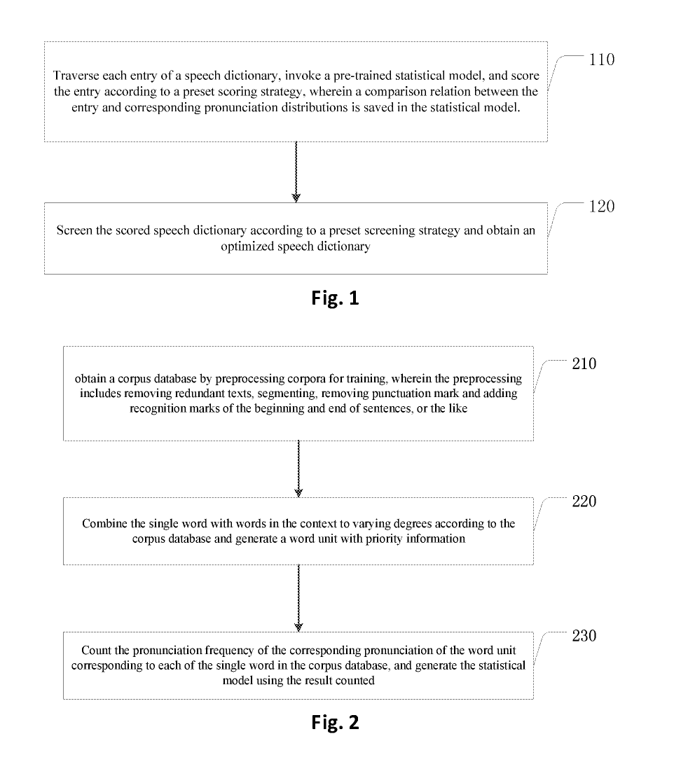

FIG. 1 is a technical flow chart of some embodiments of the present disclosure. With reference to FIG. 1, some embodiments of the present disclosure provide a method for screening effective entries of pronouncing dictionary, mainly including the following steps.

In step 110: each entry of a speech dictionary is traversed, a pre-trained statistical model is invoked, and the entry is scored according to a preset scoring strategy, wherein a comparison relation between the entry and corresponding pronunciation distributions is saved in the statistical model.

The pronouncing dictionary that describes the pronouncing method of words is an important part of a speech recognition system. The example hereinafter is a segment of the pronouncing dictionary represented by Chinese phonetic notation:

| | |
|---|---|
| bao ding shi | bao3 ding4 shi4 |
| bao fu si | bao3 fu2 si4 |
| bao fu si qiao | bao3 fu2 si4 qiao2 |

For Mandarin, a common problem is that the pronouncing dictionary often has a lot of redundant entries. The reason for this problem is that the pronouncing dictionary is usually generated by a computer through a manner of consulting dictionaries automatically, while Chinese has a lot of polyphones, and it is difficult for the computer to determine which pronunciation of the polyphones shall be used to generate the pronouncing dictionary, but to use all the pronunciations to generate entries of the pronouncing dictionary. This results in that the pronunciations of a large number of entries in the dictionary are unused in practice. For example:

| | |
|---|---|
| mei ge ren dou zhe me shuo | mei3 ge4 ren2 dou1 zhe4 me1 shu |
| mei ge ren dou zhe me shuo | mei3 ge4 ren2 dou1 zhe4 me1 shu |
| mei ge ren dou zhe me shuo | mei3 ge4 ren2 dou1 zhe4 me1 yue |
| mei ge ren dou zhe me shuo | mei3 ge4 ren2 du1 zhe4 me1 shui |
| mei ge ren dou zhe me shuo | mei3 ge4 ren2 du1 zhe4 me1 shuo |
| mei ge ren dou zhe me shuo | mei3 ge4 ren2 du1 zhe4 me1 yue4 |

In the dictionary illustrated above, although “dou” and “shuo” are polyphones, the pronunciation of the short sentence “mei ge ren dou zhe me shuo” is unique. When making a dictionary, the computer has to adopt all possible pronunciations since it cannot judge which pronunciation of “dou” and “shuo” shall be adopted, which causes a plenty of redundancy. This results in waste of memory space and increased occupation of resources for speech recognition, and also causes a certain decreasing of the recognition performance.

Some embodiments of the present disclosure obtain the statistical model by training a certain amount of corpora, read corresponding parameters from the statistical model, and evaluate the similarity between the entry in the pronouncing dictionary and the data in the statistical model; and calculate the score of the entry through a scoring mechanism, thus implementing effective entries screening.

To be specific, an implementation process is: inquiring the statistical model, and obtaining the average score of the entry according to the average pronunciation frequency of each of the single word in the entry; combining each of the single word in the speech dictionary with words in the context to varying degrees and generating a word unit with priority information; inquiring the statistical model, beginning with the word unit with highest priority, and if the pronunciation frequency corresponding to the word unit existing in the statistical model is inquired, the pronunciation frequency is served as the score of the single word; otherwise, the maximum pronunciation frequency of the single word in the statistical model is served as the score of the single word.

In step 120: the scored speech dictionary is screened according to a preset screening strategy, and obtain an optimized speech dictionary.

Particularly, a score threshold is set, and if the score of each of the single word in each group of entry set with same texts and different pronunciations is less than the score threshold, the entry having highest average score is reserved; otherwise, the entries in the entry set including the single word with a score less than the score threshold are deleted.

Some embodiments can delete invalid entries by scoring each entry in the present pronouncing dictionary and screen the entry according to the score to automatically judge whether the entry of the dictionary is an effective entry, thus effectively solving the defect of entry redundancy of the present pronouncing dictionary and reducing the resource occupancy rate of the pronouncing dictionary as well as the false detection rate of speech recognition.

FIG. 2 is a calculation flow chart of some embodiments of the present disclosure. With reference to FIG. 2, in a method for screening effective entries of pronouncing dictionary in some embodiments of the present disclosure, a statistical model is established through the following steps.

In step 210: a corpus database is obtained by preprocessing the corpora for training, wherein the preprocessing includes removing redundant texts, segmenting, removing punctuation mark and adding recognition marks of the beginning and end of sentences, or the like.

It should be illustrated that the corpora of some embodiments of the present disclosure include a certain amount of texts and corresponding phonetic notation thereof. The number of texts shall be as large as possible, and the contents thereof shall possibly cover each filed, rather than focus on limited fields. The corpus texts may be obtained through such manners as webpage crawling, transcription or directly purchasing from data providers. Meanwhile, the corpus texts have to be meaningful sentences rather than scattered Chinese characters or meaningless Chinese character combinations. Because each single word in the sentence having actual meaning has a pronunciation combined with the context, redundant corpus texts need to be removed before obtaining the corpus database, so as to obtain texts having reference meaning. In addition, phonetic notation of non-polyphones may be obtained by a computer through consulting dictionaries; while phonetic notation of polyphones are generally obtained through the manual marking of certain human resources.

The preprocessing of some embodiments of the present disclosure on the corpora further includes segmenting, removing punctuation marks, and adding recognition marks of the beginning and end of sentences, or the like. The specific operation is to segment a sentence into short sentences at the positions of comma, period, question mark and exclamation mark; delete other punctuation marks such as quotation mark, colon, guillemets, or the like; and add recognition marks at the beginning and end of each short sentence, for example, add mark <s> at the beginning of the sentence and add mark </s> at the end of the sentence. The foregoing operation may further be implemented using a regular match method, wherein the regular match method mainly obtains a target text through a regular expression and segments texts according to a preset delimiter. The regular match is a mature prior art, and will not be elaborated herein.

In step 220: the single word is combined with words in the context to different degrees according to the corpus database and a word unit with priority information is generated.

The statistical model in some embodiments of the present disclosure means a model obtained by calculating a plurality of statistical data using the processed training corpus. The statistical model training mode in some embodiments of the present disclosure may include a maximum entropy principle method, a decision tree method, a model training method based on the pronunciation probability of the context, or the like, and will not be limited by some embodiments of the present disclosure. In some embodiments, the model training method based on the pronunciation probability of the context is adopted to train the statistical model of the corpus database, wherein the main thought of the method is to count the frequency of occurrence of various pronunciations of each “word unit” in the corpora, and the “word unit” is generated by the combination of a certain single word and the words in the context of the text. In some embodiments of the present disclosure, the priorities of the generated word units with different lengths are ranked according to the degree of combining the single word with the words in the context, there may be such a priority ranking of word unit for the single word:

Type A: N words above-single word +M words hereinafter
Type B: N−1 words above-single word +M−1 words hereinafter
. . . . . . . . . . . . . . . . . . . . . . . . . . . . . . . . . . . .
Type C: one word above-single word
Type D: *−single word+one word hereinafter
Type E: *−single word +*

Wherein, the symbol “*” represents unlimited environments, the symbol “−” represents combination with the words above, and the symbol “+” represents combination with the words hereinafter; and wherein, N and M are integers, and the values of M and N are not limited, which may either be equal or different.

The priorities of the type A to type E above are in a descending order because the pronunciation of one single word is limited by the environment used thereof. In the training process of the statistical model of some embodiments, the combination between each single word and the words of the content is covered through dividing the word unit for each single word; therefore, setting the values of M and N both as 1 will not influence the training result of the model. When N=M=1, the word units obtained according to the priority are as follows.

Type A: one word above−single word+one word hereinafter

Type B: one word above−single word

Type C: *−single word+one word hereinafter

Type D: *−single word+*

The division of the word units of some embodiments is explained hereinafter through an actual example. For example, in an entry “zhe chang yin yue hui shi fen jing cai”, “yue” is a polyphone, and combining the word “yue” with words in the context thereof may obtain the following results.
Type 1: the word is “yue”, the first word in the front is “yin”, the first word behind is “hui”, and other environments are not limited. This unit is recorded as: “yin−yue+hui”
Type 2: the word is “yue”, the first word in the front is “yin”, and other environments are not limited. This unit is recorded as: “yin−yue+*”.
Type 3: the word is “yue”, the first word behind is “hui”, and other environments are not limited. This unit is recorded as: “*−yue+hui”.
Type 4: the word is “yue”, and other environments are not limited. This unit is recorded as: “*−yue+*”.

In the four types above, the single word “yue” in type 1 is respectively combined with the environment above and the environment hereinafter; therefore, the priority thereof is highest. The priorities of the types 2, 3 and 4 are reduced in sequence.

In step 230: the pronunciation frequency of the corresponding pronunciation of the word unit corresponding to each of the single word occurred in the corpus database is counted, the result of which is used for generating the statistical model.

In some embodiments, the word units of all types corresponding to each single word are inquired, and the pronunciation frequency corresponding to each of the word unit is counted to obtain the pronunciation distributions of each single word in the corpus database, wherein these pronunciation distributions are namely the statistical model.

To continue the example above, the pronunciation distributions of “yue” in the entry “zhe chang yin yue hui shi fen jing cai” may have the following results.

| | | | |
|---|---|---|---|
| Type 1 | “yin-yue + hui” | yue4: 100% | le4: 0% |
| Type 2 | “yin-yue + *” | yue4: 98% | le4: 2% |
| Type 3 | “*-yue + hui” | yue4: 76% | le4: 24% |
| Type 4 | “*-yue + *” | yue4: 57.8% | le4: 42.2% |

In some embodiments, the pronunciation distributions of each single word are obtained through processing the present corpus database and statistics training; therefore, when screening the effective entries of the pronouncing dictionary subsequently, corresponding pronunciations may be automatically inquired and matched quickly and effectively through matching with the statistical model, and the effective entries is screened.

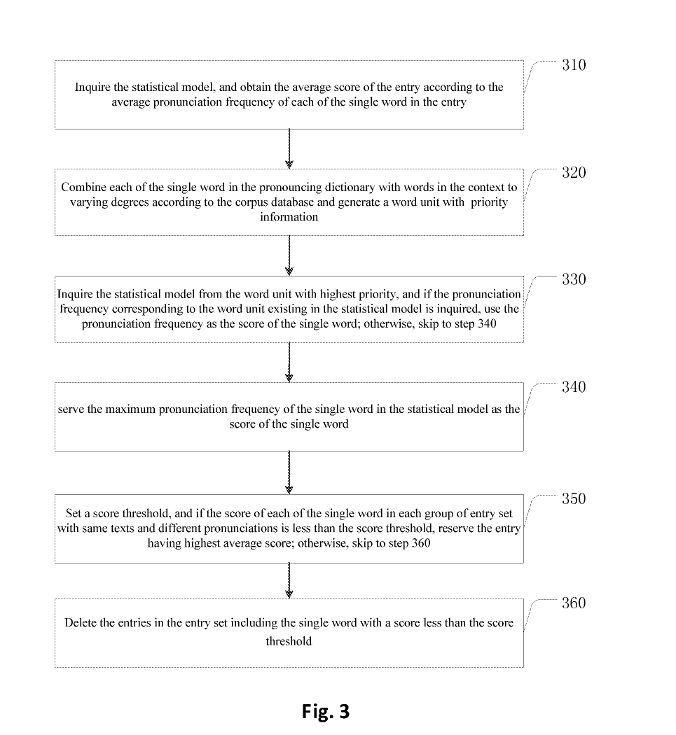

FIG. 3 is a technical flow chart of some embodiments of the present disclosure. With reference to FIG. 3, a process of invoking a pre-trained statistical model and scoring the entry according to a preset scoring strategy and thus implementing effective entries screening in a method for screening effective entries of pronouncing dictionary of some embodiments of the present disclosure is mainly implemented through the following steps:

In step 310: the statistical model is inquired, and the average score of the entry is obtained according to the average pronunciation frequency of each of the single word in the entry.

In some embodiments, it is provided that an entry to be detected is “mei miao de yin yue rang ren chen zui”, which corresponds to two pronunciations in the pronouncing dictionary; because “yue” in the entry is a polyphone, and the pronunciation of “yue” in the foregoing entry is unique, a correct pronunciation entry needs to be screened.

In some embodiments, the pronunciation frequency of each single word in the entry “mei miao de yin yue rang ren chen zui” is calculated out firstly, and the average score of the entry is calculated out according to the pronunciation frequency of each single word. The average score is used in a subsequent screening process; and meanwhile, the minimum scores of the single words in the entry are counted, and these scores are used as a vector for subsequent pronunciation entry screening.

In step 320: each of the single word in the pronouncing dictionary is combined with words in the context to varying degrees according to the corpus database and a word unit with priority information is generated.

The performing process of this step is the same as that of step 220 in some embodiments, and will not be elaborated herein. The generation result of the word units is illustrated by one actual example only herein. To continue the entry “mei miao de yin yue rang ren chen zui” in the step above, the word units corresponding to the single word “yue” ranked according to the priority are as follows.

| | |
|---|---|
| Type 1 | “yin-yue + rang” |
| Type 2 | “yin-yue + *” |
| Type 3 | “*-yue + rang” |
| Type 4 | “*-yue + *” |

In step 330: the statistical model is inquired beginning with the word unit with highest priority, and if the pronunciation frequency corresponding to the word unit existing in the statistical model is inquired, the pronunciation frequency is served as the score of the single word; otherwise, it shall be skipped to step 340.

In some embodiments, the statistical model is checked whether to have the pronunciation distributions of the word unit corresponding to type 1; if yes, then the pronunciation frequency of the single word of the pronouncing dictionary in the model is served as the score of the word. If the pronunciation distributions of the word unit corresponding to type 1 are not found, then type 2, type 3 and type 4 are inquired in sequence until the pronunciation distributions are found, and the frequency value corresponding to the pronunciation distributions is served as the score of the single word.

For example, the pronunciation distributions of the word unit corresponding to type 1 “yin−yue−rang” are not found in the statistical model, then the pronunciation distributions of the word unit corresponding to type 2 “yin−yue+*” in the model are inquired. While the frequency of the pronunciation yue4 is inquired as 97.66%, the score of the word “yue” is 0.9766, and the scoring of the word “yue” is finished.

It is noteworthy that step 320 and step 330 may also have the following implementation manners.

The word unit corresponding to type 1, i.e., the word unit with environments in front and behind, is generated firstly. The statistical model is checked whether to have the pronunciation distributions of the word unit; if yes, then the pronunciation frequency of the single word of the pronouncing dictionary in the model is served as the score of the word. If the pronunciation distributions of the word unit corresponding to type 1 are not found, then type 2, type 3 and type 4 are generated in sequence until the pronunciation distributions are found, and the frequency value corresponding to the pronunciation distributions is used as the score of the single word.

In step 340: the maximum pronunciation frequency of the single word in the statistical model is served as the score of the single word.

If the corresponding pronunciation distributions are not found in all the word units having the context environment corresponding to the single word, then the maximum value in the pronunciation distributions of the single word is served as the score of the singleword.

For example, for the word unit “yin−yue+rang” in the statistical model, none of the corresponding pronunciation distributions of “yin−yue+*” and *−yue+rang” are found, while the pronunciation frequency of yue4 corresponding to “yue” is 55%, which is more than 50%, then 0.55 is served as the score of the word “yue”.

In step 350: a score threshold is set, and if the score of each of the single word in each group of entry set with same texts and different pronunciations is less than the score threshold, the entry having highest average score is reserved; otherwise, it shall be skipped to step 360.

Based on the scoring result of the above step, there may be various entry screening strategies, for example: reserving the entry having an average score greater than a predetermined value, reserving the entry having a minimum score greater than the predetermined value, reserving the entry having single words with a score greater than the predetermined value greater than a predetermined proportion, or the like, which will not be limited by some embodiments of the present disclosure. Some embodiments will adopt a more efficient screening strategy, i.e., setting a score threshold, and if the score of each of the single word in each group of entry set with same texts and different pronunciationsis less than the score threshold, reserving the entry having highest average score. This screening process will be illustrated hereinafter through an example.

It is provided that an entry to be screened is “xin quing hao”, the scoring results thereof are obtained as follows.

| Average score | Minimum of | Score of each | |
|---|---|---|---|
| of the entry | single word | single word | Pronunciations |
| 0.036 | 0.645 | [1.000 0.900 0.036] | xin1 qing2 hao1 |
| 0.900 | 0.966 | [1.000 0.900 1.000] | xin1 qing2 hao3 |
| 0.019 | 0.639 | [1.000 0.900 0.019] | xin1 qing2 hao4 |

It is provided that the score threshold is 0.2, then in the group of entry set with same texts and different pronunciations, it is not that the score of each of the single word is less than the score threshold; therefore, it shall be skipped to step 360.

In step 360: the entries in the entry set including the single word with a score less than the score threshold are deleted.

To continue the example above, the score of “hao1” in the two pronunciations including xin1 qing2 hao1 and xin1 qing2 hao4 is 0.036, and the score of “hao4” is 0.019, both of which are less than the score threshold; therefore, the entries having the two pronunciations are deleted, and the effective entry “xin xin1 qing qing2 hao hao3” is reserved.

In some embodiments, it determines whether the entry in the pronouncing dictionary is an effective entry according to the statistical model, which changes the defect of entry redundancy of the present pronouncing dictionary, and optimizes the present pronouncing dictionary; meanwhile, compared with the defect of the prior art that requires a lot of artificial work to screen invalid entries, some embodiments of the present disclosure implements highly efficient and low-cost deletion of the invalid entries automatically.

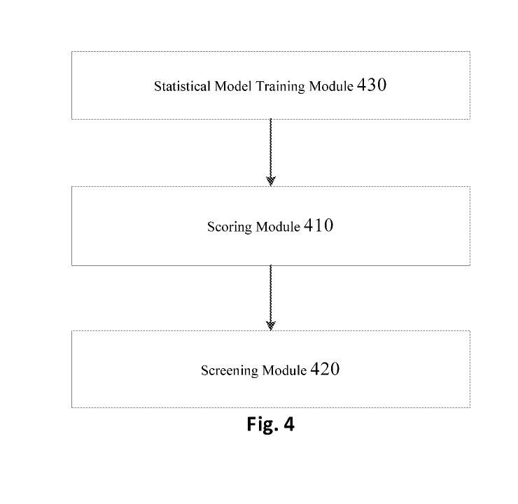

FIG. 4 is a structural diagram of a device of some embodiments of the present disclosure. With reference to FIG. 4, some embodiments of the present disclosure provide a device for screening effective entries of pronouncing dictionary, mainly including the following modules: a scoring module 410, a screening module 420 and a statistical model training module 430.

The scoring module 410 is configured to traverse each entry of a speech dictionary, invoke a statistical model pre-trained by the statistical model training module 430, and score the entry according to a preset scoring strategy, wherein a comparison relation between the entry and corresponding pronunciation distributions is saved in the statistical model.

The screening module 420 is configured to screen the speech dictionary scored by the scoring module 410 according to a preset screening strategy, and obtain an optimized speech dictionary.

Further, the statistical model training module 430 is configured to adopt the following steps to train the statistical model according to corpora:

obtaining a corpus database by preprocessing the corpora for training, wherein the preprocessing includes removing redundant texts, segmenting, removing punctuation mark and adding recognition marks of the beginning and end of sentences, or the like;

combining a single word with words in the context to different degrees according to the corpus database and generating a word unit with priority information; and

count the pronunciation frequency of the corresponding pronunciation of the word unit corresponding to each of the single word occurred in the corpus database, and generate the statistical model using the result counted.

Further, the scoring module 410 is configured to inquire the statistical model and obtain the average score of the entry according to the average pronunciation frequency of each of the single word in the entry;

combine each of the single word in the speech dictionary with words in the context to varying degrees and generate a word unit with priority information;

inquire the statistical model beginning with the word unit with highest priority, and if the pronunciation frequency corresponding to the word unit existing in the statistical model is inquired, serve the pronunciation frequency as the score of the single word; otherwise, serve the maximum pronunciation frequency of the single word in the statistical model as the score of the single word.

Further, the screening module 420 is configured to set a score threshold, and if the score of each of the single word in each group of entry set with same texts and different pronunciations is less than the score threshold, reserve the entry having highest average score; otherwise, delete the entries in the entry set including the single word with a score less than the score threshold.

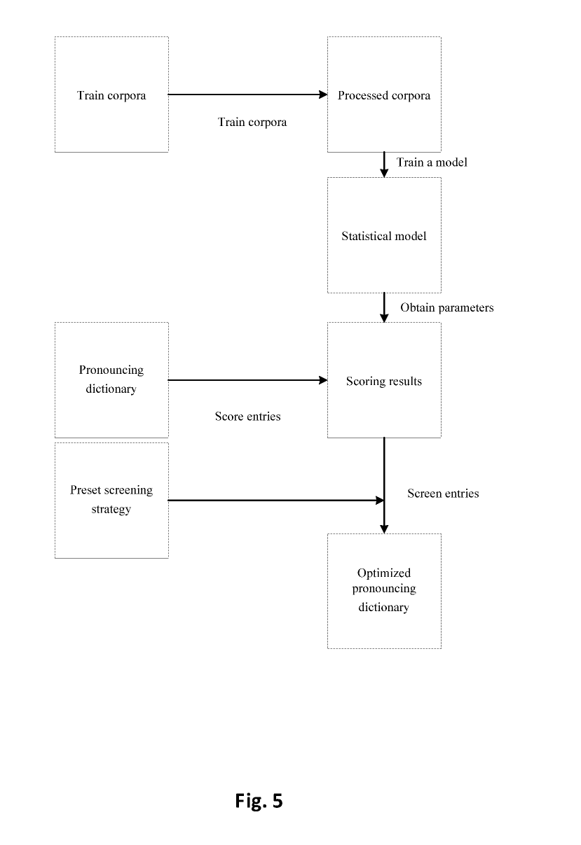

The device as shown in FIG. 5 may execute the methods of some embodiments corresponding to FIG. 1, FIG. 2 and FIG. 3, and the implementation principle and technical effects may refer to the contents of some embodiments corresponding to FIG. 1, FIG. 2 and FIG. 3, and will not be elaborated herein.

Specific implementation processes for training the statistical model and using the statistical model in the method for screening effective entries of pronouncing dictionary of some embodiments of the present disclosure will be elaborated hereinafter through a specific example.

a corpus database is obtained by preprocessing corpora for training firstly, wherein the preprocessing includes removing redundant texts, segmenting, removing punctuation mark and adding recognition marks of the beginning and end of sentences, or the like. The texts in the corpus database have to be meaningful sentences rather than scattered Chinese characters or meaningless Chinese character combinations. For example, the following texts are not complied with the requirements:

```
    cha ba da fa a si fa, de wei sa
    yue men zui de shuo qu xing you biao bu tan shen shi te de biao
    hua ren ai jun she xiao ran xin. jiao kai jia shi le you guo men hai dui
jiao li fen
    ku jian tou shu bao xian
```

The following is an example of texts that complies with the requirements:

```
    ji dian kai shi ne
    bu xing, wo zhe zhou mo hai you “kao shi” ne, xia zhou zen me yang
    dan shi gong zuo zhen de hen nan zhao, zui jin hao xiang hen fan, wo
ye mei he ta shuo
gei wo hui ge dian hua hao me
```

Corresponding marks in phonetic notation shall also be provided for each Chinese character in the text. For example, marks in phonetic notation are added for the foregoing effective texts in the example hereinafter:

```
      ji-ji2 dian-dian3 kai-kai1 shi-shi3 ne-ne5
      bu-bu4 xing-xing2, wo-wo3 zhe-zhe4 zhou-zhou1 mo-mo4 hai-
hai2 you-you2 “kao-kao3 shi-shi4” ne-ne5, xia-xia4 zhou-zhou1
zen-zen3 me-me5 yagn-yagn4
      dan-dan4 shi-shi4 gong-gong1 zuo-zuo4 zhen-zhen1 de-de5 hen-
hen3 nan-nan2 zhao-zhao3, zui-zui4 jin-jin4 hao-hao3 xiang-xiang4
hen-hen3 fan-fan2, wo-wo2 ye-ye3 mei-mei2 he-he2 ta-ta1 shuo-shuo1
      gei-gei2 wo-wo3 hui-hui2 ge-ge4 dian-dian4 hua-hua4 hao-hao3
ma-ma5
```

The corpora are processed as follows:

segmenting the sentence into short sentences at the positions of comma, period, question mark and exclamation mark;

deleting other punctuation marks such as quotation mark, colon, guillemet, or the like;

adding mark <s> at the beginning of the sentence and adding mark </s> at the end of the sentence;

The processed corpus examples are as follows:

```
      > ji-ji2 dian-dian3 kai-kai1 shi-shi3 ne-ne5 </s>
      <s> bu-bu4 xing-xing2 </s>
      <s> wo-wo3 zhe-zhe4 zhou-zhou1 mo-mo4 hai-hai2 you-you2
kao-kao3 shi-shi4 ne-ne5 </s>
      <s> xia-xia4 zhou-zhou1 zen-zen3 me-me5 yang-yang4 </s>
      <s> dan-dan4 shi-shi4 gong-gong1 zuo-zuo4 zhen-zhen1 de-de5
hen-hen3 nan-nan2 zhao-zhao3 </s>
      <s> zui-zui4 jin-jin4 hao-hao3 xiang-xiang4 hen-hen3 fan-fan2
      </s>
      <s> wo-wo2 ye-ye3 mei-mei2 he-he2 ta-ta1 shuo-shuo1 </s>
      <s> gei-gei2 wo-wo3 hui-hui2 ge-ge4 dian-dian4 hua-hua4
hao-hao3 ma-ma5 </s>
```

The training corpus database required by the statistical model is thus obtained.

The single word is combined with words in the context to different extent according to the corpus database and a word unit with priority information is generated. For example, possible units of a word “zhang” in a sentence “wo cong xiao zhang zai he bian” may include the followings:

Type 1: the word is “zhang”, the first word in the front is “xiao”, and the first word behind is “zai”, and other environments are not limited. This unit is recorded as: “xiao−zhang+zai”.

Type 2: the word is “zhang”, the first word in the front is “xiao”, and other environments are not limited. This unit is recorded as: “xiao−zhang+*”.

Type 3: the word is “zhang”, the first word behind is “zai”, and other environments are not limited. This unit is recorded as: “*−zhang+zai”.

Type 4: the word is “zhang”, and other environments are not limited. This unit is recorded as: “*−zhang+*”.

The pronunciation distributions of each unit in the corpora are counted. Here is an example of the statistics results.

| | | |
|---|---|---|
| xiao-zhang + zai | zhang3: 100.00% | |
| xiao-zhang + * | chang2: 67.66% | zhang3: 32.34% |
| *-zhang + zai | chang2: 10.12% | zhang3: 89.88% |
| *-zhang + * | chang2: 57.78% | zhang3: 42.22% |

These statistics results just constitute the statistical model.

A group of scores between 0 and 1 shall be given for each entry in the pronouncing dictionary. A manner for scoring is to score each Chinese character in the dictionary entry respectively according to the statistical model, and finally count the average value and the minimum of the scores of each word in the entry.

The word unit corresponding to type 1, i.e., the word unit with environments in front and behind, is generated firstly. The statistical model is checked whether to have the pronunciation distributions of the unit. If the pronunciation distributions of the unit are found, then the pronunciation frequency of the single word of the pronouncing dictionary in the model is used as the score of the word. If the pronunciation distributions of the word unit corresponding to type 1 are not found, then type 2, type 3 and type 4 are generated in sequence until the pronunciation distributions are found.

For instance, for the scoring of a word “chang” in a dictionary entry xiao chang jia xiao3 chang2 jia4, a unit “xiao−chang+jia” corresponding to type 1 is generated firstly, and the pronunciation distributions of the unit are not found in the model; therefore, a unit “xiao−chang+*” corresponding to type 2 is generated, and the pronunciation distributions thereof are founded in the model, and the frequency of the pronunciation chang2 is acquired as 67.66%; therefore, the score of the word “chang” is 0.6766, and the scoring of this word is finished.

For another instance, for the scoring of a word “chang” in a dictionary entry da chang jin da4 chang2 jin1, the pronunciation distributions thereof in the model are not found when generating the units corresponding to type 1, type 2 and type 3; therefore, type 4 “*−chang+*” is adopted, i.e., the pronunciation distributions of the context are not considered. The frequency of the pronunciation chang2 obtained is 57.78%; therefore, the score of the word “chang” obtained is 0.5778.

Each word in the entry is scored according to the foregoing step, and meanwhile, the average score and the minimum score of each single word of the entry are counted. These scores are served as a vector for subsequent pronunciation entry screening.

Based on the scoring results of the previous step, the threshold is set as 0.2. For each group of dictionary entry set with same texts and different pronunciations, if the scores of all the single words are less than the threshold, then the entry having the maximum average score is reserved; otherwise, the entry having a score less than the threshold is deleted.

For example, for the scored entries below:

| | | value score of | | |
|---|---|---|---|---|
| minimum | average | each single word | text | pronunciations |
| 0.036 | 0.645 | [1.000 0.900 | xin qing hao | xin1 qing2 hao1 |
| | | 0.036] | | |
| 0.900 | 0.966 | [1.000 0.900 | xin qing hao | xin1 qing2 hao3 |
| | | 1.000] | | |
| 0.019 | 0.639 | [1.000 0.900 | xin qing hao | xin1 qing2 hao4 |
| | | 0.019] | | |

According to the screening strategy above, the entry xin1 qing2 hao3 is reserved only.

The above step is used to screen a pronouncing dictionary, wherein the results are as follows:

| | Original | New |
|---|---|---|
| Comparison type | dictionary | dictionary |
| Number of dictionary entries | 899,000 | 592,000 |
| Occupied magnetic disk space | 45M | 26 MB |
| Accuracy of entries applied to | 91.06% | 91.78% |
| a speech recognition system | | |

It can be seen from the results that the device of the present disclosure compresses the size of the dictionary significantly, while the accuracy improves instead of decreasing.

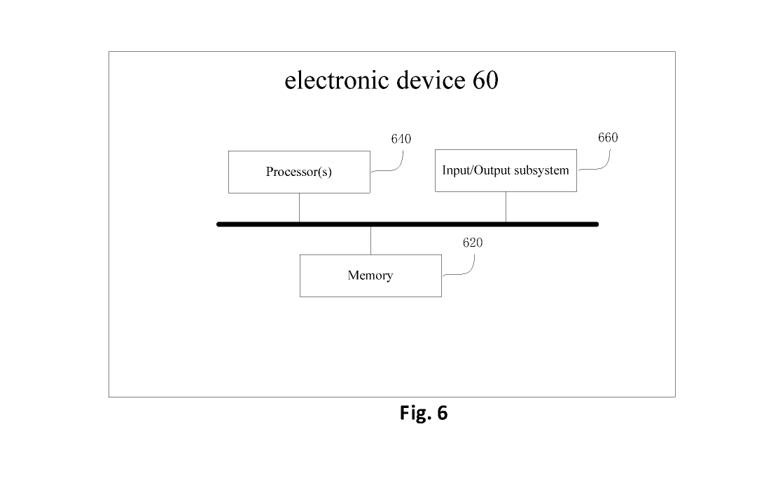

Attention is now directed toward embodiments of an electronic device. FIG. 6 is a block diagram illustrating an electronic device 60. The electronic device may include memory 620 (which may include one or more computer readable storage mediums), at least one processor 640, and input/output subsystem 660. These components may communicate over one or more communication buses or signal lines. It should be appreciated that the electronic device 60 may have more or fewer components than shown, may combine two or more components, or may have a different configuration or arrangement of the components. The various components may be implemented in hardware, software, or a combination of both hardware and software.

The memory 620, as a non-volatile computer readable storage medium, may be configured to store non-volatile software programs, non-volatile computer executable programs and modules, for example, the program instructions/modules corresponding to the methods for screening effective entries of a pronouncing dictionary in some embodiments of the present application. The non-volatile software programs, instructions and modules stored in the memory 620, when being executed, cause the at least one processor 640 to perform various function applications and data processing, that is, performing the methods for screening effective entries of a pronouncing dictionary in the above method embodiments.

The memory 620 may also include a program storage area and a data storage area. The program storage area may store an operating system and an application implementing at least one function. The data storage area may store data created according to use of the device for screening effective entries of a pronouncing dictionary. In addition, the memory 620 may include a high speed random access memory, or include a non-volatile memory, for example, at least one disk storage device, a flash memory device, or another non-volatile solid storage device. In some embodiments, the memory 620 optionally includes memories remotely configured relative to the processor 640. These memories may be connected to the device for screening effective entries of a pronouncing dictionary over a network. The above examples include, but not limited to, the Internet, Intranet, local area network, mobile communication network and a combination thereof.

One or more modules are stored in the memory 620, and when being executed by the one or more processors 640, perform the method for screening effective entries of a pronouncing dictionary in any of the above method embodiments.

The product may perform the method according to the embodiments of the present application, has corresponding function modules for performing the method, and achieves the corresponding beneficial effects. For technical details that are not illustrated in detail in this embodiment, reference may be made to the description of the methods according to the embodiments of the present application.

The electronic device in the embodiments of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and

(5) another electronic device having the data interaction function.

Some embodiments are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of some embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of each embodiment of the present disclosure.

What is claimed is:

1. A method for screening effective entries of a pronouncing dictionary, comprising the following steps:
at an electronic device:
traversing each entry of a pronouncing dictionary, invoking a pre-trained statistical model, and scoring the entry according to a preset scoring strategy, wherein a comparison relation between the entry and corresponding pronunciation distributions is saved in the statistical model; and
screening the scored pronouncing dictionary according to a preset screening strategy and obtaining an optimized pronouncing dictionary.

2. The method according to claim 1, further comprising:
obtaining a corpus database by preprocessing corpora for training,
wherein the preprocessing comprises one or a combination of several of removing redundant texts, segmenting, removing punctuation mark and adding recognition marks of the beginning and end of sentences; and
training and obtaining the statistical model according to the corpus database.

3. The method according to claim 2, wherein the training and obtaining the statistical model according to the corpus database comprises:
combining a single word in the corpus database with words in the context and generating a word unit according to the corpus database; and
counting the pronunciation frequency of the corresponding pronunciation of the word unit corresponding to the single word occurred in the corpus database, and
generating the statistical model using the result counted.

4. The method according to claim 3, wherein the scoring the entry according to the preset scoring strategy comprises:
inquiring the statistical model, and
obtaining the average score of the entry according to the average pronunciation frequency of each of the single word in the entry;
using two or more than two combination manners to combine each of the single word in the pronouncing dictionary with the words in the context and generating a plurality of corresponding word units;
determining the priority of the plurality of word units according to the preset priority of the combination manners;
inquiring the statistical model beginning with the word unit with highest priority, and
if the pronunciation frequency corresponding to the word unit existing in the statistical model is inquired, serving the pronunciation frequency as the score of the single word; otherwise,
serving the maximum pronunciation frequency of the single word in the statistical model as the score of the single word.

5. The method according to claim 1, wherein the screening the scored pronouncing dictionary according to the preset screening strategy to obtain the optimized pronouncing dictionary further comprises:
setting a score threshold, and
if the score of each of the single word in each group of entry set with same texts and different pronunciations is less than the score threshold, reserving the entry having highest average score; otherwise,
deleting the entries in the entry set comprising the single word with a score less than the score threshold.

6. An electronic device for screening effective entries of a pronouncing dictionary, comprising:
at least one processor; and
a memory communicably connected with the at least one processor for storing instructions executable by the at least one processor, wherein execution of the instructions by the at least one processor causes the at least one processor to:
traverse each entry of a pronouncing dictionary, invoke a pre-trained statistical model, and score the entry according to a preset scoring strategy, wherein a comparison relation between the entry and corresponding pronunciation distributions is saved in the statistical model; and
screen the scored pronouncing dictionary according to a preset screening strategy and obtain an optimized pronouncing dictionary.

7. The electronic device according to claim 6, wherein at least one processor is further caused to:
preprocess corpora configured to train to obtain a corpus database, wherein the preprocessing comprises one or a combination of several of removing redundant texts, segmenting, removing punctuation mark and adding recognition marks of the beginning and end of sentences; and
train and obtain the statistical model according to the corpus database.

8. The electronic device according to claim 7, wherein the train and obtain the statistical model according to the corpus database comprises:
combine a single word in the corpus database with words in the context and generate a word unit according to the corpus database; and
count the pronunciation frequency of the corresponding pronunciation of the word unit corresponding to the single word occurred in the corpus database, and generate the statistical model using the result counted.

9. The electronic device according to claim 8, wherein the score the entry according to the preset scoring strategy comprises:
inquire the statistical model, and obtain the average score of the entry according to the average pronunciation frequency of each of the single word in the entry;
use two or more than two combination manners to combine each of the single word in the pronouncing dictionary with the words in the context and generate a plurality of corresponding word units;
determine the priority of the plurality of word units according to the preset priority of the combination manners;
inquire the statistical model from the word unit with highest priority, and if the pronunciation frequency corresponding to the word unit existing in the statistical model is inquired, serve the pronunciation frequency as the score of the single word; otherwise,
serve the maximum pronunciation frequency of the single word in the statistical model as the score of the single word.

10. The electronic device according to claim 6, wherein the screen the scored pronouncing dictionary according to the preset screening strategy to obtain the optimized pronouncing dictionary further comprises:
set a score threshold, and if the score of each of the single word in each group of entry set with same texts and different pronunciations is less than the score threshold, reserve the entry having highest average score; otherwise,
delete the entries in the entry set comprising the single word with a score less than the score threshold.

11. A non-transitory computer-readable storage medium storing executable instructions that, when executed by an electronic device with a touch-sensitive display, cause the electronic device to perform the method according to claim 1.
